(19) United States
(12) Patent Application Publication
(10) Pub. No.: US 2026/0116239 A1
(43) Pub. Date: Apr. 30, 2026

(54) INDEPENDENT TIMER BASED VEHICLE CHARGING

(71) Applicant: FCA US LLC, Auburn Hills, MI (US)

(72) Inventors: Pavan Kumar Mukkara Srinivas, Auburn Hills, MI (US); Nandhashree Mugalur Srinivasaiah, Auburn Hills, MI (US)

(21) Appl. No.: 18/929,790

(22) Filed: Oct. 29, 2024

(51) Int. Cl. B60L 53/64; B60L 53/62; B60L 53/66; G06Q 30/0283; G06Q 50/06

(52) U.S. Cl. CPC B60L 53/64; B60L 53/62; B60L 53/66; G06Q 30/0283; G06Q 50/06; B60L 2250/14

(57) ABSTRACT

A system and method for optimizing charge time for a vehicle may include a controller that is capable of communicating with a charger for a vehicle and also with an external device. The controller may receive a user alarm time set by a user, determine an estimated charge time based at least in part on the user alarm time, and control a charge cycle of a battery as a function of the estimated charge time. The user alarm time is set on a device that is not part of the charger and may be set for a purpose other than to limit the charging time for a vehicle charge cycle. For example, the alarm time may be a user wake time for the following day.

### FIELD

The present disclosure relates to a system for optimizing charge time of an electric vehicle based on a sleep or similar timer set by a user.

### BACKGROUND

Some vehicles with a rechargeable battery may prioritize speed of charge cycles, which reduces the lifespan of the battery over repeated cycles. Other vehicles may use slower charging cycles resulting in incomplete charging during shorter charge cycles. However, the user may not drive the vehicle at predicable times, and so users often cannot select a charge cycle tie or charge scheme at the time they plug their vehicle into a charger resulting in the vehicle being undercharged or charged inefficiently.

### SUMMARY

In at least some implementations, a method for optimizing charge time for a vehicle may include the steps of receiving a user alarm time set by a user, determining an estimated charge time based at least in part on the user alarm time, and controlling a charge cycle of a battery as a function of the estimated charge time.

In at least some implementations, when the estimated charge time is later than a time the battery is expected to reach a predetermined charge level under present charging conditions, an electrical power provided to the battery is decreased.

In at least some implementations, when the estimated charge time is later than a time the battery is expected to reach a predetermined charge level under present charging conditions, an electrical power provided to the battery is increased.

In at least some implementations, the estimated charge time includes a first period of time in which electricity costs are higher than a second period of time during the estimated charge time, and the electrical power provided to the battery is decreased during at least a portion of the first period of time.

In at least some implementations, the estimated charge time includes a first period of time when electricity costs are lower than during a second period of time during the estimated charge time, and the provided to the battery is increased during at least a portion of the first period of time.

In at least some implementations, the estimated charge time includes a first period of time in which electricity costs are higher than a second period of time during the estimated charge time, and the electrical power provided to the battery is decreased during at least a portion of the first period of time.

In at least some implementations, the estimated charge time includes a first period of time when electricity costs are lower than during a second period of time during the estimated charge time, and the electrical power provided to the battery is increased during at least a portion of the first period of time.

In at least some implementations, when, prior to the estimated charge time passing a new user alarm time is received, the estimated charge time is revised and determined based at least in part on the new user alarm time, and the charge cycle of a battery is controlled as a function of the revised estimated charge time.

In at least some implementations, when, prior to the estimated charge time passing the user alarm time is cleared or removed, the battery charges under normal charging conditions until the battery reaches a predetermined charge level.

In at least some implementations, the method also includes determining if the vehicle is connected to a power source after the user alarm time is received.

In at least some implementations, a system for optimizing charge time for a vehicle may include a controller that includes one or more processors, memory and instructions or programs stored in the memory or otherwise accessible by the processors that is capable of communicating with a charger for a vehicle or with a vehicle, or both, and also with an external device. The controller to receive a user alarm time set by a user, determine an estimated charge time based at least in part on the user alarm time, and control a charge cycle of a battery as a function of the estimated charge time.

In at least some implementations, the system also includes determining if the vehicle is connected to a power source after the user alarm time is received.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a schematic of a system for optimizing charge time for a vehicle, including an external device, a power supply, and a vehicle;

FIG. 2 shows a first flow chart for a method for optimizing charge time for a vehicle;

FIG. 3 shows a second flow chart for a method for optimizing charge time for a vehicle;

FIG. 4 shows a third flow chart for a method for optimizing charge time for a vehicle.

### DETAILED DESCRIPTION

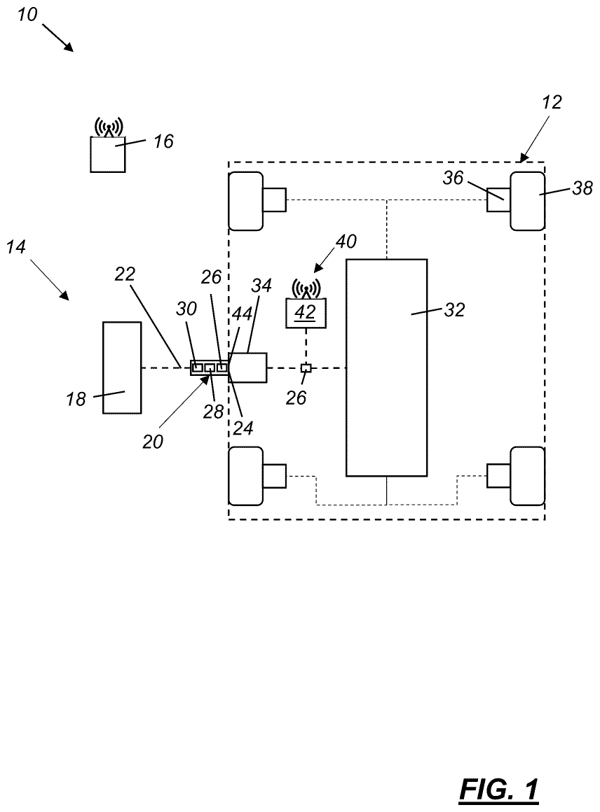

Referring in more detail to the drawings, FIG. 1 shows a system 10 for optimizing charge time for a vehicle 12. The system 10 includes a power supply 14, a vehicle 12, and an external device 16 by which a user can set a sleep or other timer, such as to use as an alarm clock. The power supply 14 includes a power source 18 and a charger 20. The power source 18 may be a local source of electrical power or current and may be powered by an electrical system supplied by a power grid, solar panels, windmill, or other electrical supply and is in electrical communication with the charger 20 to provide power through the charger 20 to the vehicle 12.

The charger 20 may include a cable 22, a connector 24, a charger control unit or charger controller 26, and a receiver 28. The cable 22 is in electrical communication with both the power source 18 and the connector 24 to transfer electrical power from the power source 18 to the connector 24. The connector 24 is adapted to be coupled to a vehicle charge port, and may include electrically conductive contacts that are in electrical communication with the power source 18. The charger 20 may also include the charger controller 26, which have or be part of a control system 30 having one or more processors, memory and instructions or programs stored in the memory or otherwise accessible by the processors. The charger controller 26 may be capable of altering the electricity supplied (e.g. current and/or the voltage) from the power source 18 to the connector 24. A receiver 28 may be in communication with the charger controller 26 to receive information and communicate information to the charge controller 26, for example, to provide instructions to selectively alter the current and/or the voltage from the power source 14 to the connector 24. The receiver 28 may be capable of receiving communication(s) from one or more components of the vehicle 12 and/or an external device 16.

The vehicle 12 may include a battery 32, charge port 34, one or more motors 36, wheels 38 driven by the motor(s), and a control system 40 including a charge controller 42. The battery 32 may be mounted to or within the vehicle 12 and may be one or more batteries each having one or interconnected cells arranged in series and/or parallel to achieve a desired voltage and capacity. Any suitable battery composition may be used, including but not limited to lithium-ion, nickel-metal hydride, lead-acid types. The battery 32 is in electrical communication with the charge port 34 and one or more motors 36 of the vehicle 12. Electrical power from the battery 32 is used to power the motor(s) 34 to drive the wheels 38 and propel the vehicle 12.

The charge port 34 may be a connector 44 containing electrically conducive contacts in electrical communication with the battery 32. To facilitate access from a user, the charge port 34 may be accessible from beyond an exterior of the vehicle 12 and integrated within a body of the vehicle 12. The charge port 34 is configured to interact with the connector 24 of the charger 20, permitting electrical communication between the power source 18 and the battery 32 through the electrically conducive contacts of the charger 20 and the electrically conducive contacts of the charge port 34.

The charge controller 42 may be in communication with the charger controller 26 and may control or selectively alter the current and/or the voltage from the power source 18 to the battery 32. The charge controller 42 may have one or more processors, memory and instructions or programs stored in the memory or otherwise accessible by the processors, and may communicate with the receiver 28 of the charger controller 26 and the external device 16. While both a charger controller 26 (that is part of the charger 20) and a charge controller 42 (that is part of the vehicle 12) are described, one control unit may be used to control the supply of power from the charger 20 to the vehicle battery 32, as desired.

The external device 16 may be separate from the vehicle 12, have one or more processors, memory and instructions or programs stored in the memory or otherwise accessible by the processors, a transmitter, a receiver and a user interface. The external device 16 is capable of taking input from a user and sending the user input to the charge controller 42 of the vehicle 12 and/or to the charger controller 26. Non-limiting examples of external devices 16 include smartphones, tablets, computers and other devices connected or connectable to the internet and controlled or used by the user. In at least some implementations, the external device 16 has an application or feature capable of taking a user alarm time as an input from a user, and notifying the user when the user alarm time occurs. For example, this application may be used as an alarm clock to wake a user from sleep at a predetermined time, remind a user to do something at a predetermined time, or to remind a user to prepare to leave for an event at a predetermined time. The external device 16 is not part of the charger 20 or the vehicle 12, and in at least some implementations, the alarm time is set for a purpose other than an independent of setting a charge duration for vehicle charging. That is, the user sets the alarm time for a purpose unrelated to the vehicle charging, in at least some implementations, and the system uses this time to determine appropriate charge cycle parameters (time, electrical current flow rates, etc).

In at least some implementations, the alarm time is set for an overnight or otherwise extended sleep period. An overnight/extended sleep period may be determined by an alarm duration that includes a majority of the hours a user normally sleeps, for example, a majority of the hours between 10 μm and 6 am. At least for many users, setting an overnight sleep alarm time is an indication of an intent to sleep for an extended period, during which time the vehicle 12 will be parked and not in use. Some users may sleep during the daytime, and so a sleep timer that is repeated and includes daytime hours may be determined by the system to involve an extended sleep period, or a user may provide an input to the system to note usual sleep period times.

In at least some implementations, the external device 16 may communicate the alarm time set by a user to the vehicle 12 and/or the charger 20. The alarm time set by the user on the external device 16 may be communicated through known methods of wireless communication such as but not limited to WiFi, Bluetooth, cellular, or satellite communications. After being received by the vehicle 12 and/or the charger 20, the user alarm time may be used by the charger controller 26 and/or the vehicle charge controller 42 to vary the electrical power supplied to the battery 32 from the power source 18 over time.

In normal operation of charging a vehicle 12 with the power supply 14, a user plugs the cable 22 into the charge port 34 and electrical current flows from the power source 14 through the charger 20 and the charge port 34 to the vehicle battery 32. One or both of the charger controller 26 and the vehicle charge controller 42 controls the rate of charging and may also set a threshold or a predetermined level of charge that the battery 32 will reach during a charge cycle.

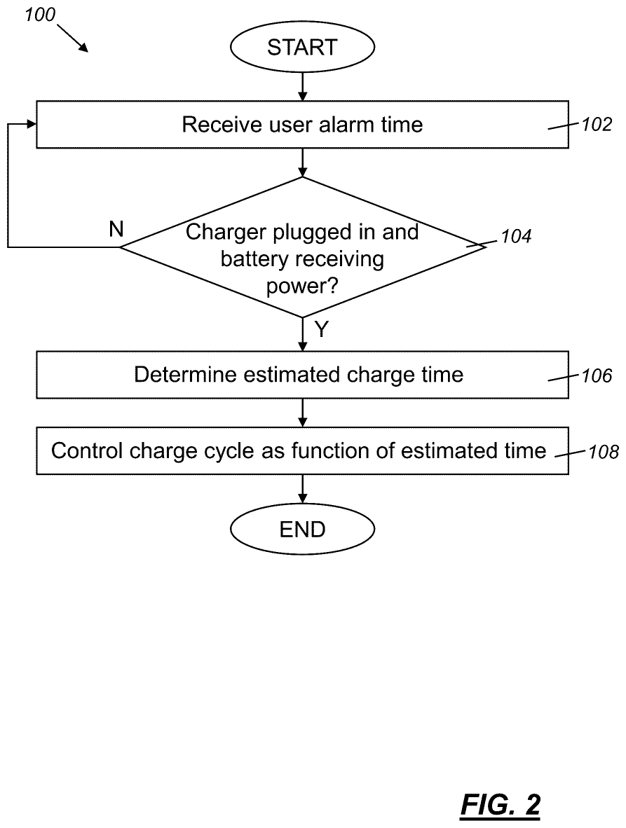

FIG. 2 depicts a method 100 for optimizing charge time for a vehicle 12. In step 102, the vehicle charge controller 42 and/or the charger 20 receives the alarm time input by the user via the external device 16. In at least some implementations, the program providing the alarm time option to the user can automatically provide the alarm time to the controller 42 or the charger 20, or the program can provide a prompt asking the user if they would like to communicate the alarm time with the vehicle charge controller 42 or charger 20. When the user alarm time is received, in step 104, the controller 42 determines whether the vehicle 12 is connected to the charger 20 and can receive electrical current, and if so, the method continues to step 106.

In step 106, an estimated charge time is determined based at least in part on the user alarm time. The estimated charge time could be, by way of non-limiting examples, a total duration of time from the start of a charge event or charge cycle to the alarm time or an end time based at least in part on the alarm time, or the estimated charge time could be the time of the day by which the battery 32 will be charged to a predetermined charge level (e.g. the end time). Based on the estimated charge time, the rate or rates at which the battery will be charged can be determined. The rate(s) at which the battery will be charged may be optimized for battery life, efficiency, cost or other factors.

For example, charging at higher levels of electrical current may degrade the battery capacity and performance over repeated charge cycles throughout the life of the battery 32. The estimated charge time may be optimized to use lower power levels over an extended charging interval to prevent excessive wear on the battery 32, promoting battery life and longevity. In markets with variable rates for electricity, the estimated charge time may account for electricity costs by minimizing energy use during times of elevated cost, and increasing energy use for charging during times with lower energy cost. For example, the estimated charge time may include a first period of time in which electricity costs are higher than a second period of time during the estimated charge time, and the current from the charger may be decreased during at least a portion of the first period of time to reduce electricity costs. Alternatively, the estimated charge time may include a first period of time when electricity costs are lower than during a second period of time during the estimated charge time, and the current from the charger may be increased during at least a portion of the first period of time to optimize costs.

Furthermore, when the user alarm time occurs and the user receives an alert from the external device 16 it is often an indication to the user to begin to prepare to leave for an event, for example, go to work, an appointment or other event or place. Because the user might not rush straight to the vehicle after an alarm is turned off, there can be a potentially significant delay between the time the alert occurs and the time the user unplugs the vehicle 12 from charging. After repeated cycles of setting the user alarm time while the vehicle 12 is charging, the controller 42 can learn statistically significant patterns such as the average and the standard deviation of time taken between the user alarm time occurring and the user unplugging the charger 20 from the charge port 34, and can use this time in determinations of the estimated charge time for future charge cycles. This analysis may be done based on the day of week (e.g. work day habits may be different from non-work day habits), time of day of the alarm time (e.g. habits may be different for earlier in the day alarm times than for later in the day alarm times), and may other factors, as desired. In this way, the end of charge time or total estimated charge time is based on the user set alarm time but the estimated charge time need not always end right at the alarm time.

In step 108, the charge cycle of the battery 32 is controlled as a function of the estimated charge time. To control the charge cycle, the charge controller 42 and/or the charger controller 26 may vary the current supplied to the battery 32. To charge the battery 32 to a predetermined level at or before the estimated charge time, the current from the charger 20 may need to be increased from a nominal charge rate to accelerate the rate of charge of the battery 32 or decreased from the nominal charge rate to slow the rate of charge of the battery 32. If the estimated charge time is later than the time the battery 32 is expected to reach the predetermined charge level under normal or present charging conditions, the current from the charger 20 can, in at least some implementations, be decreased such that that battery 32 reaches the predetermined charge level by or before the estimated charge time. Conversely, if the estimated charge time is earlier than the time the battery 32 is expected to reach the predetermined charge level under normal or present charging conditions, the current from the charger 20 may be increased such that the battery 32 reaches or gets as close as possible to the predetermined charge level by the estimated charge time. If the first estimated charge time passes and the battery 32 has reached the predetermined level without any changes made to the user alarm time the method 100 and charging end.

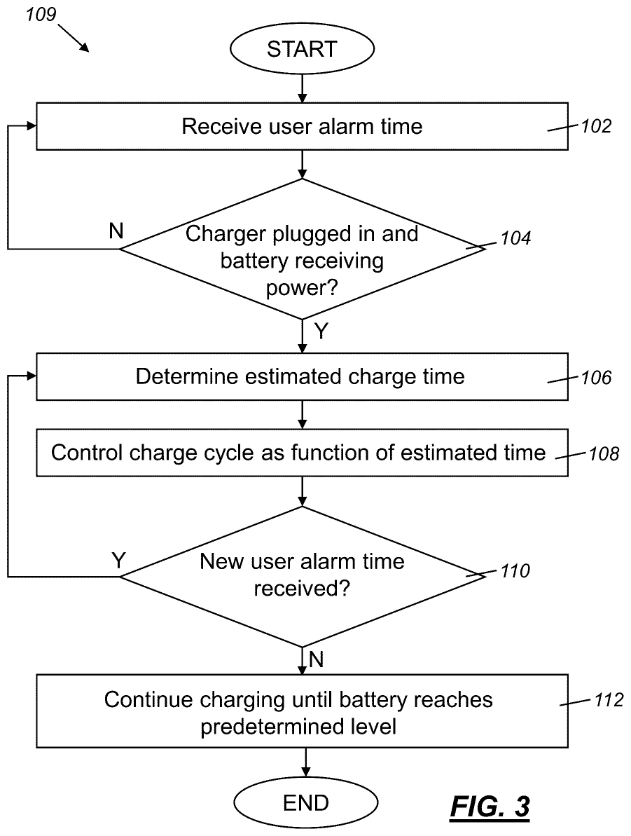

The method 109, shown in FIG. 3, includes steps 102-108 as in the method 100 of FIG. 2, and includes additional steps. As shown in FIG. 3, in step 110 if it is determined that the user inputted a new user alarm time into the external device 16 prior to the first estimated charge time passing, the method 100 continues to step 112. Otherwise, the charge cycle continues until the first estimated time passes and the battery 32 has reached the predetermined level. In step 112, the controller 42 receives the new user alarm time from the external device 16, the method returns to step 106 with the new/second user alarm time replacing the former/first user alarm time, and a new estimated charge time is determined as a function of the new user alarm time.

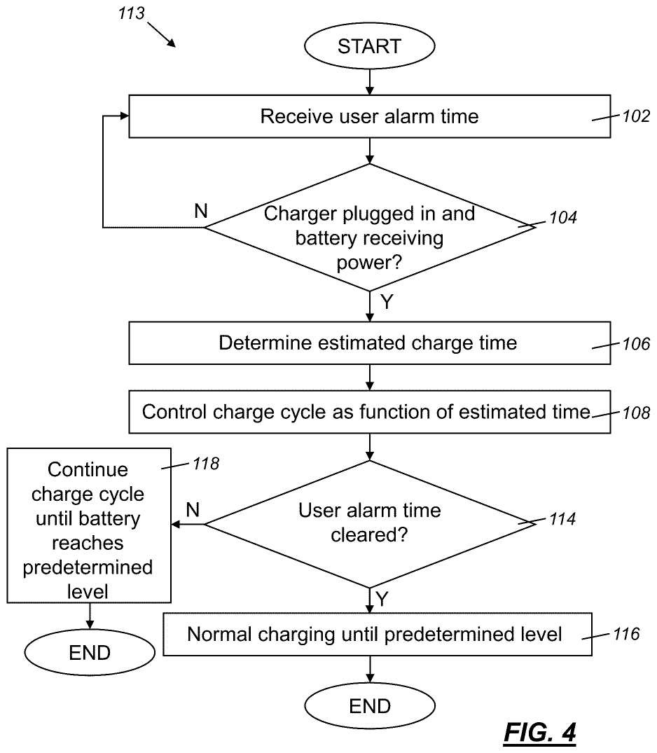

The method 113, shown in FIG. 4, includes steps 102-108 as in the method 100 of FIG. 2, and includes additional steps. As shown in FIG. 4, in step 114, if the user clears or removes the user alarm time from the external device 16 prior to the user alarm time occurring, charging of the vehicle battery 32 may continue in step 116 under normal or system default charging conditions established prior to the user alarm time being set, or otherwise as determined by the charger 20 or vehicle charge controller 42. The method may end after step 118, when the battery 32 reaches the predetermined charge level.

The systems 10 and methods 100, 109, 113 disclosed herein facilitate efficient and effective charging of a vehicle battery 32 or batteries without requiring a user to enter a charge cycle duration into the charger 20 or vehicle 12. Instead, during the normal course or routine of their day, a user may set an alarm time for a different purpose, independently of vehicle charging, such as to ensure the user wakes up at a predetermined time. For example, many people use the alarm functions of their smartphones to control their waking time. Of course, other devices, like an alarm clock or other electronic device can be used by a user to set the alarm time, and for such devices that are connected to the internet (e.g. so-called “smart” devices) the alarm time can then be communicated to one or both of the vehicle charge controller 42 and the charger 20.

The alarm time provides an indication of when the vehicle 12 might be used, and so by when the charge cycle should be completed. In this way, a user need not set a charge duration when the vehicle 12 is initially plugged into the charger 20, at a time when the user might not have planned their wake time or other alarm time. By communicating the alarm time from the external device 16 to the vehicle 12 and/or charger 20, the user need not set multiple timers and the process is greatly simplified for the user. In at least some implementations, this can occur automatically by software that causes the alarm time to be transmitted by the external device 16 after the user selects or sets the alarm time on the external device 16. Some systems and methods may allow additional time beyond the alarm time, as noted above, based on user habits or preset assumptions as to the time after the alarm time by which the vehicle 12 might be used. Beyond simplifying the process for the user, the vehicle charging can be done more efficiently, more cost-effectively and with improved component life.

What is claimed is:

1. A method for optimizing charge time for a vehicle, the method comprising the steps of:
receiving from an external device a user alarm time set by a user;
determining an estimated charge time based at least in part on the user alarm time;
controlling a charge cycle of a battery as a function of the estimated charge time.

2. The method of claim 1 wherein, when the estimated charge time is later than a time the battery is expected to reach a predetermined charge level under present charging conditions, an electrical power provided to the battery is decreased.

3. The method of claim 1 wherein, when the estimated charge time is earlier than a time the battery is expected to reach a predetermined charge level under present charging conditions, an electrical power provided to the battery is increased.

4. The method of claim 2 wherein, the estimated charge time includes a first period of time in which electricity costs are higher than a second period of time during the estimated charge time, and the electrical power provided to the battery is decreased during at least a portion of the first period of time.

5. The method of claim 2 wherein, the estimated charge time includes a first period of time when electricity costs are lower than during a second period of time during the estimated charge time, and the electrical power provided to the battery is increased during at least a portion of the first period of time.

6. The method of claim 3 wherein, the estimated charge time includes a first period of time in which electricity costs are higher than a second period of time during the estimated charge time, and the electrical power provided to the battery is decreased during at least a portion of the first period of time.

7. The method of claim 3 wherein, the estimated charge time includes a first period of time when electricity costs are lower than during a second period of time during the estimated charge time, and the electrical power provided to the battery is increased during at least a portion of the first period of time.

8. The method of claim 1 wherein, when, prior to the estimated charge time passing a new user alarm time is received, the estimated charge time is revised and determined based at least in part on the new user alarm time, and the charge cycle of a battery is controlled as a function of the revised estimated charge time.

9. The method of claim 1 wherein, when, prior to the estimated charge time passing the user alarm time is cleared or removed, the battery is charged under normal charging conditions.

10. The method of claim 1 which also includes determining if the vehicle is connected to a power source after the user alarm time is received.

11. A system for optimizing charge time for a vehicle, comprising:
a controller that includes one or more processors, memory and instructions or programs stored in the memory or otherwise accessible by the processors, the controller is adapted to communicate with a charger for a vehicle or with a vehicle charge controller, or both, and also with an external device to:
receive from an external device a user alarm time set by a user;
determine an estimated charge time based at least in part on the user alarm time; and
control a charge cycle of a battery as a function of the estimated charge time.

12. The system of claim 11 wherein, when the estimated charge time is later than a time the battery is expected to reach a predetermined charge level under present charging conditions, an electrical power provided to the battery is decreased.

13. The system of claim 11 wherein, when the estimated charge time is later than a time the battery is expected to reach a predetermined charge level under present charging conditions, an electrical power provided to the battery is increased.

14. The system of claim 12 wherein, the estimated charge time includes a first period of time in which electricity costs are higher than a second period of time during the estimated charge time, and the current provided to the battery is decreased during at least a portion of the first period of time.

15. The system of claim 12 wherein, the estimated charge time includes a first period of time when electricity costs are lower than during a second period of time during the estimated charge time, and the electrical power provided to the battery is increased during at least a portion of the first period of time.

16. The system of claim 13 wherein, the estimated charge time includes a first period of time in which electricity costs are higher than a second period of time during the estimated charge time, and the electrical power provided to the battery is decreased during at least a portion of the first period of time.

17. The system of claim 13 wherein, the estimated charge time includes a first period of time when electricity costs are lower than during a second period of time during the estimated charge time, and the electrical power provided to the battery is increased during at least a portion of the first period of time.

18. The system of claim 11 wherein, when, prior to the estimated charge time passing a new user alarm time is received, the estimated charge time is revised and determined based at least in part on the new user alarm time, and the charge cycle of a battery is controlled as a function of the estimated charge time.

19. The system of claim 11 wherein, when, prior to the estimated charge time passing the user alarm time is cleared or removed, the battery charges under normal charging conditions until the battery reaches a predetermined charge level.

20. The system of claim 11 which also includes determining if the vehicle is connected to a power source after the user alarm time is received.
